(19) United States
(12) Patent Application Publication
(10) Pub. No.: US 2013/0094441 A1
(43) Pub. Date: Apr. 18, 2013

(54) SYSTEM, METHOD, DEVICE FOR WIRELESS DEVICE ASSOCIATION, PROGRAM DOWNLOAD, AND EXCHANGE OF DATA BETWEEN WIRELESS DEVICES

(71) Applicant: Simon MILNER, San Jose, CA (US)

(72) Inventor: Simon MILNER, San Jose, CA (US)

(21) Appl. No.: 13/482,400

(22) Filed: May 29, 2012

Related U.S. Application Data
(60) Provisional application No. 61/627,572, filed on Oct. 17, 2011.

(51) Int. Cl. H04W 4/00

(52) U.S. Cl. 370/328

(57) ABSTRACT

A system for automatically associating a first wireless device with a second wireless device comprising a wireless device that toggles between client mode and access point mode. The first device communicates using first access point device when is client mode. When the first wireless device switches to access point mode it forms a pulsed overlay wireless network. The first wireless device transmits a unique identifier over the pulsed overlay wireless network to the second wireless device. When the second wireless device receives and detects the unique identifier, a token is transmitted over the first wireless network to the second and wherein the token is configured with a mobile device identifier that uniquely identifies the second client device.

### RELATED APPLICATION

This application claims priority under 35 U.S.C. §119(e) of the co-pending U.S. provisional patent application Ser. No. 61/627,572 filed on Oct. 17, 2011, and titled “SYSTEM, METHOD, AND DEVICE FOR THE AUTOMATIC ASSOCIATION OF WIRELESS DEVICES.” The provisional patent application Ser. No. 61/627,572 filed on Oct. 17, 2011, and titled “SYSTEM, METHOD, AND DEVICE FOR THE AUTOMATIC ASSOCIATION OF WIRELESS DEVICES” is hereby incorporated by reference.

### FIELD OF THE INVENTION

This invention relates generally to electronic processing systems, methods and devices for the automatic association of wireless devices, the download of programs to wireless devices, and the exchange of data between wireless devices.

### BACKGROUND

Mobile wireless devices configured with with geographic social group application software require a user to manually interact with the mobile device to check into a location or associated with a group. For example, the social networking site Foursquare® provides a mobile application that when activated sends location information by GPS (Global Positioning System), cellular triangulation, or by other means to a network coupled server that then determines if other associated mobile devices are in the same geographic area. Further, a user when in proximity to a business can check into a remote service through a local or wide area network to take advantage of promotions. However, the mobile device application requires manual user input to make an association. Further, it requires the mobile device to have GPS or some other geo-location means to send the geo-location information to a service for associating with other geographically co-located devices.

What is needed is a system, method, and device that automatically associates the mobile device, a client device, and a geographic location of the client device where the mobile device does not require a GPS or other geo-locating means and does not require manual steps in making the association.

A further application is for devices with wireless connectivity that need configuration upon power-up. Configuration can include a SSID (Service Set Identifier) for WiFi connectivity, security key, and a download of the most up to date application software.

What is needed is an automated means for configuration, application download or exchanging data without requiring a physically connection to the device.

### BRIEF DESCRIPTION OF THE DRAWINGS

FIG. 1 is a block diagram illustrating an exemplary network environment used in accordance with certain embodiments of the invention.

FIG. 2 is a block diagram of an exemplary computing device suitable to implement an Pulse Access Point Client.

FIG. 3 is a process diagram showing the process for automatically associating two wireless devices.

FIG. 4 is a process diagram for downloading and configuring a device in accordance with certain embodiments of the invention.

FIG. 5 is a system diagram of an exemplar network environment for downloading and configuring devices.

### SUMMARY OF THE INVENTION

In one aspect of the invention a system provides for automatically associating a first wireless device with a second wireless device. The first wireless device toggles between wireless client mode and access point mode. In the client mode, the first wireless device communicates through a first wireless network. The first wireless network is formed by a first access point device. The first wireless device toggles into access point mode thereby forming a pulsed overlay wireless network. Pulsed refers making a wireless network for a short time period at predetermined times. While in the access point mode, the first device transmits a unique identifier over the pulsed overlay wireless network. After toggling into client mode, the first wireless device is configured to receive a token from a second wireless device.

Further, the system comprises a second wireless device configured to receive the unique identifier over the pulsed overlay wireless network. The second wireless device is configured to search a data structure on the second wireless devices which contains identifiers of the wireless networks within range of the second wireless device. Software on the second wireless device will search for a unique type of wireless networks identifiers. Upon finding the unique type of identifier, a token is transmitted over the first wireless network to the first wireless device. The token contains a unique identifier of the second wireless device.

In a further embodiment, the system can include a network coupled service. When the first wireless device receives the token, it generates and sends a message to the network coupled service. The message includes an identifier of the first wireless device and the unique identifier of the second wireless device. The message can include but is not limited to information such as time, a preprogrammed geo-location of the first wireless device.

The service can store an association between the first wireless device and the second wireless device. The service can then search for a third other wireless devices associated with the first wireless device. Further the search can include further restrictions such as belonging to a social group. If another wireless device is found, a message can be sent to either the second, third, or both wireless devices. The message can include but is not limited to a status update of the other devices proximity. The wireless communication protocol can include WiFi or Bluetooth based on the standards IEEE 802.11a, b, g, and n or IEEE 802.15.

In another aspect of the invention, a method of associating a first wireless device with a second wireless device is disclosed. The process is comprised of the steps of configuring a first wireless device form a wireless client mode configuration to a wireless access point mode configuration. While in the access point mode, the first wireless device forms a temporary wireless network or a pulsed overlay wireless network.

In a next step of the process, and after entering the access point mode, the first wireless device transmits an identifier unique to the first wireless device. The identifier is received by a second wireless device that is within reception range of the first wireless device.

The second device periodically searchs a data structure on the second device for a unique wireless device identifier. The wireless device identifier can have a unique field that identifies it as a PAPC type device.

Upon detecting the unique identifier the second wireless device sends a token to the first wireless device through the first wireless network. The token contains a unique identifier of the second wireless device.

In an optional step, the first wireless device sends a message to a network coupled service. The message contains the first wireless device identifier and the second wireless device identifier. The association of the first wireless device and the second wireless device is stored in a database coupled to the service.

In a further step, the database is searched for a third wireless device associated with the first wireless device. If a third device is found, a notification is sent over the first network from the network coupled service to the second wireless device. The message contains information associated with the third wireless device. This information could include but is not limited to name or phone number associated with the third device.

In another aspect of the present invention, a wireless device is configured to automatically associate with a second wireless device. The device comprises electronics configured to toggle between a wireless client mode device and a wireless access point device. The device is configured to communicate through a first wireless network associated with a first access point device when configured in client mode. When the device is configured in access point mode the device forms a pulsed overlay wireless network. After toggling into the access point mode, the device is configured to transmits a unique device identifier over the pulsed overlay wireless network. The identifier in one embodiment is a SSID which both identifies the device as a PAPC type device. When in the client mode the device is configured to receive wirelessly a token over the first wireless network from a second wireless device.

In a further embodiment, the device configured to send a message to a network coupled service over the first wireless network, wherein the message contains the mobile device identifier and a first wireless device identifier. In one embodiment, the device uses the communication standards specified by IEEE 802.11a, b, g, and n or IEEE 802.15 for the wireless communication.

### DETAILED DESCRIPTION OF THE INVENTION

The following description of the invention is provided as an enabling teaching of the invention. Those skilled in the relevant art will recognize that many changes can be made to the embodiment described, while still attaining the beneficial results of the present invention. It will also be apparent that some of the desired benefits of the present invention can be attained by selecting some of the features of the present invention without utilizing other features. Accordingly, those skilled in the art will recognize that many modifications and adaptations to the present invention are possible and can even be desirable in certain circumstances, and are a part of the present invention. Thus, the following description is provided as illustrative of the principles of the present invention and not a limitation thereof.

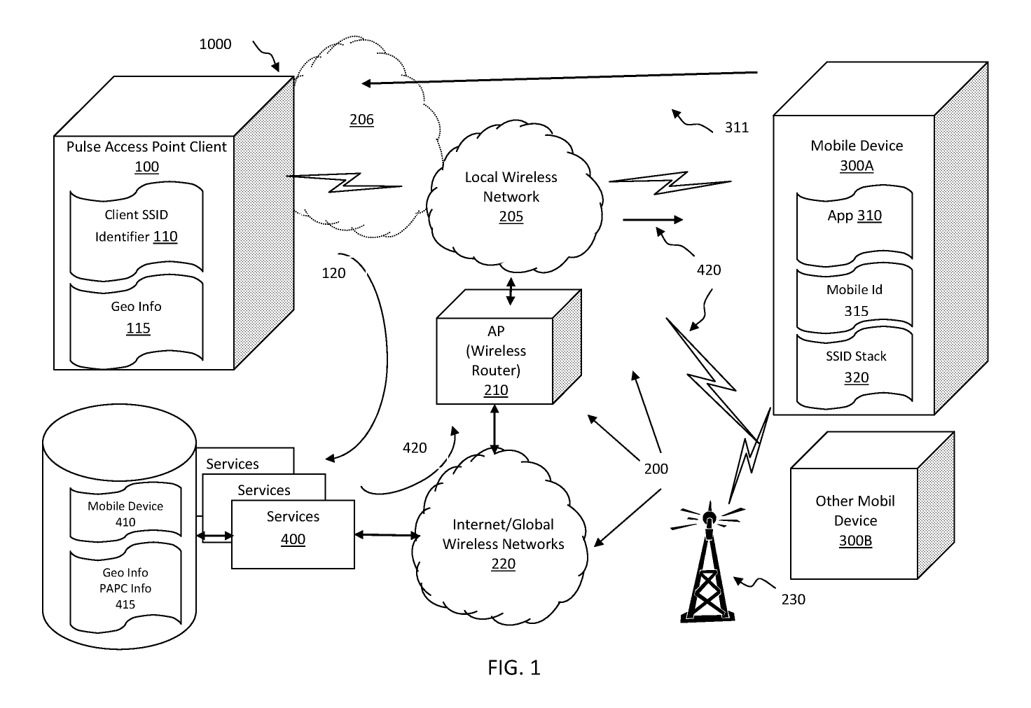

FIG. 1 is a schematic depiction of a system 1000 that automatically associates a mobile devices 300A with a known and new type of wireless device referred to as a PAPC 100 (Pulsed Access Point client), sends a token message from the mobile device 300A to the PAPC 100 and sends an association message 120 to a network coupled service 400 where the association is stored in a database 410. Optionally the service 400 determines if there is another mobile device 300B that is within range of the pulsed overlay wireless network 206 and previously associated with the PAPC 100, and optionally sends a notification of the associated mobile devices 300A, 300B to one or more of the mobile devices 300A, 300B connected to same local wireless network 205.

The PAPC 100 functions by periodically toggling from a wireless client device connected to the local wireless network 205 to a wireless access point device operating in the same manner as the AP 210 (Access Point Wireless Router). Thus, the PAPC 100 forms an pulsed overlay wireless network 206 to which no devices, such as wireless devices 300A and 300B, are expected to connect but are expect to receive a PAPC 100 broadcasted unique identifier 110. Current WiFi networks use a SSID 110 (Service Set Identifier) as a unique identifier but other unique identifiers are contemplated.

Upon the PAPC 100 toggling into access point mode, the PAPC 100 will transmit a preconfigured or partially preconfigured SSID 110. For example, the transmitted SSID 110 can be an ASCI character string such as “FeedAir0156803” where the first part of the SSID “FeedAir” can represent one PAPC type device recognizable by mobile device application software 310 and the second half of the SSID “0156803” can uniquely identify the PAPC 100 device. This SSID 110 will be received by all mobile client devices within the reception range of the pulsed overlay wireless network 206. However, only a mobile wireless device 300A configured with the application software 310 with respond to the preconfigured SSID because non-configured wireless devices are not configured to try to connect to the PAPC 100. No wireless devices are expected to connect to the PAPC 100 but only receive the PAPC 100 transmited identifier.

The time spent by the PAPC device in the access point mode is preferably relatively short. This may range from 0.1 seconds to one second. The time between toggling can range between thirty seconds and two minutes.

While the PAPC 100 is in the client mode, the device is configured to receive a token 311 from one or more mobile devices 300A, 300B over the wireless network 205. When received, the tokens indicate that the mobile device 300A has received a PAPC SSID 110. The mobile device 300A is configured with application software 310 to search the wireless SSID stack 320 or other SSID related data structures for a PAPC type SSID 110. FeedAirxxxx is exemplar of an SSID that is both identifiable as a PAPC type device, “FeedAir”, and is uniquely identifiable, “xxxx”. The token 311 is formed to include a unique identifier 315 for the mobile device 300A. Further, this identifier 315 is known by one or more network coupled services 400. When received by the PAPC 100, a token is then combined with the unique identifier 110 identifying the PAPC 100 and can include other configured information. This information can include but not limited to PAPC 100 geographic location information 115. This information is formed into a message 120 that can be sent to a network coupled service 400.

The mobile wireless device 300A is configured with application software 310 that can run as a background task. The mobile wireless device 300A includes but is not limited to a mobile phone, tablet computer, laptop computer, and personal digital assistant and must be configured with a wireless communication means. Preferably, the communication means incorporates IEEE 802.11(a, b, g, and n) WiFi or IEEE 802.15 Bluetooth but other wireless communication standards and protocols are contemplated.

The mobile device 300A application software 310 periodically monitors the mobile device wireless software SSID stack 320 to check for the reception by the WiFi electronics of a PAPC type SSID. The monitoring can include software that scans wireless stack associated data structures, can be a software hook into the wireless stack, or by other means that does not significantly interferes with the operation or performance of the mobile device 300A. If the partially or fully predetermined SSID 110 is found in the mobile device SSID stack 320, the application software 310 is configured to search over the local wireless network 205 for the PAPC 100 client. The application software 310 is configured to send to the PAPC 100 client, through the wireless network 205, a token 311 containing a mobile device identifier 315. The mobile device 300A identifier 315 can be configured by the mobile device application 310 or by a service.

The network coupled service 400 is configured to receive a message that can include PAPC 100 configuration information 110, 115, and the mobile device identifier 315 information of the mobile device 300A associated with the PAPC device 100. Further, the service 400 can determine what other mobile device 300B has recently associated with the PAPC 100. Optionally, the service 400 can determine whether any of the associated mobile devices 300B are associated with a predetermined group 415 and send a notification message 420 to one or more mobile devices 300A, 300B. The messages 420 can include the mobile devices 300A proximity to other mobile devices 300B that are currently associated with the PAPC 100 and thereby provide notification that the associated members of a group are nearby. Further the message can include associated information in the 400 database including a name or phone number. Alternatively, the message can be in the nature of an advertisement or information about the associated owner of the PAPC 100 device.

The network services 400 are coupled to a database 410 that can include information about one or more PAPCs 100, mobile devices (300A, 300B), a preconfigured notification message, and can include group association information about the mobile devices 300A, 300B.

The database information about one or more PAPC 100 devices can include but is not limited to an SSID identifier for each PAPC 100, geographic location information associated with each PAPC 100, one or more mobile devices 300A, 300B associated with each PAPC 100, the time and date that the mobile devices 300A, 300B associated with PAPC 100, and a time period after which a person will be presumed to have left the geographic proximity of an associated PAPC 100. Further, the service 400 and database 410 can keep track of notification messages sent to mobile devices that are associated with each PAPC 100.

The network 200 is comprised of any global or private packet network or telecom network including but not limited to the Internet and cellular and telephone networks 220, and access equipment including but not limited to wireless routers 210. Preferably the global network 220 is the Internet and cellular network running standard protocols including but not limited to TCP, UDP, and IP. The cellular network 230 can include cellular 3G and 4G networks, satellite networks, cable networks, associated optical fiber networks and protocols, or any combination of these networks and protocols required to transport the tokens 311 and notification message 420 to and from the network coupled services 400, PAPC 100, and mobile devices 300A, 300B.

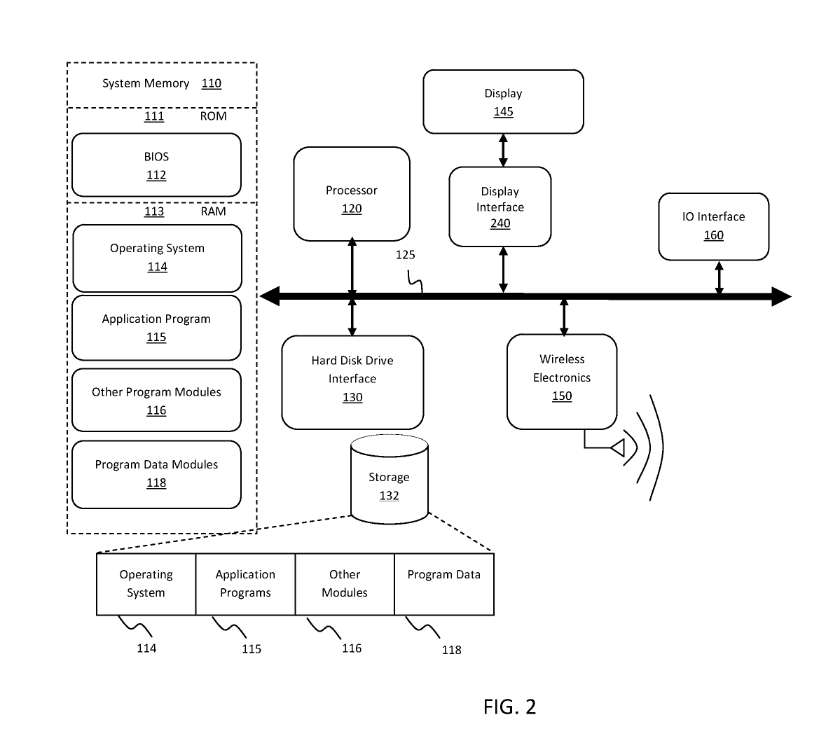

Referring to FIG. 2, a schematic depiction is shown of one embodiment of a PAPC 100 that can be used in accordance with the invention. The PAPC 100 is a self contained digital server that includes a processor 120, system memory 110, storage 132, a bus 125, and wireless communication electronics 150 for periodically toggling the PAPC 100 from client mode to access point mode and send and receiving wireless messages. The PACP 100 contains machine executable instructions that when executing can switch the wireless communication electronics from a client mode to an access point mode and back, receive token messages from associated mobile devices 300A, and send association messages of a mobile device 300A with the PAPC 100, to a network coupled Service 400.

The bus 125 represents one or more of any of several types of bus structures, including a memory bus or memory controller, a peripheral bus, and a processor or local bus using any of a variety of bus architectures. The system memory 110 includes ROM 111 (read only memory) and RAM 113 (random access memory). The ROM 111 comprises a BIOS 112 (basic input/output system) that contains basic routines for transferring data between elements within the PAPC 100 such as during start-up. The PAPC 100 further includes a storage drive interface 130 for reading from and writing to storage 132.

The storage device 132 provides nonvolatile storage of computer readable instructions, data structures, program modules, and other data for the PAPC 100. Although the exemplary environment described herein employs solid state memory, it will be appreciated by those skilled in the art that other types of computer readable media which can store data that is accessible by a computer, such as hard disks, magnetic cassettes, flash memory cards, RAMs, ROM, and the like, can also be used in the exemplary operating environment. A number of program modules may be stored on the storage 132, including an operating system 114, one or more application programs 115 including the pulse access point client application, other program modules 116, and program data 118.

The processor 120 can be any processor with sufficient processing power to support wireless connectivity and sufficient memory address space to support applications toggling the wireless communication electronics from a client mode to an access point mode, receiving token messages, and sending association messages of a mobile device with the PAPC 100 to a network coupled service 400. Preferably, the processor 120 requires minimal power and has a small foot print. A low power PAPC 100 is a device that can be powered by a USB connector. Preferably the processor 120 is part of an integrated device with system memory 110 and storage 132 and possibly other components such as a means for low power wireless transmissions.

The wireless electronics 150 can be for any type of wireless communication standard where the access point provides an identifier and the client device maintains a list of seen access points. Preferable, the wireless transmission supports wireless communication means commonly found on a mobile device such as mobile phone. The wireless standards IEEE 802.11 WiFi and IEEE 802.15 Bluetooth are two common communication standards that are commonly found on mobile devices.

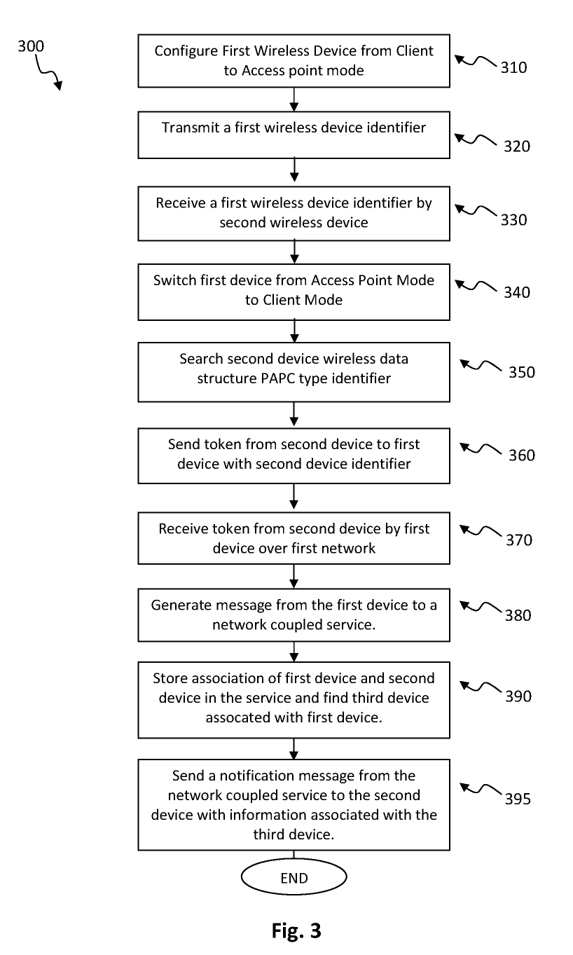

Referring to FIG. 3, a process diagram for automatically associating two wireless devices is specified. Some of the steps are optional.

In a step 310 a first wireless device's configuration is changed from a client mode connected to a first wireless network to access point mode. In access point mode the first device identifies itself to any client device within reception range by transmitting a device identifier. As an access point device the first device forms a temporary pulsed wireless network associated with the first device.

In a step 320, while in the access point mode, the first device transmits a wireless device identifier. Preferably the identifier is unique and will identify it as a type of device that switches back and forth between a client and access point wireless device. For the wireless transmission protocol IEEE 802.11 WiFi and IEEE 802.15 Bluetooth, the identifier is a configurable SSID (Service Set Identifier). Preferably, the SSID can be configured to an identifier that uniquely identifies the device as a PAPC type device and uniquely identifies that device.

In a step 330, a second wireless device receives the identifier of the first wireless device. This identifier is stored in a data structure associated with the second wireless device.

In a step 340, the first wireless device is reconfigured as a client device and connects to a first wireless network.

In a step 350, the second wireless device searches the wireless data structure associated with the second device for a specific type of SSID. The SSID has a portion of the identifier that identifies it as a type of device that toggles between client mode and access point mode.

In a step 360, the second wireless device sends a token to the first wireless device over the first wireless network. The token contains data that identifies the second wireless device. Preferably the data uniquely identifies the second wireless device. This data can be but is not limited to a cell phone number, hardware identifier, a configured identifier, a MAC address, or a downloaded identifier.

In a step 370, the first device receives the token transmitted by the second devic over the first wireless network.

In an optional step 380, the first device generates a message containing first device identifier and data that identifies the second device. This message can include preconfigured location information. The message is transmitted to the network coupled service.

In an optional step 390, the network coupled service stores the association of the first device with the second device in a data structure. Further, the service searches the data structure for a third device that is associated with the first device.

In an optional step 395, information about the third device is sent in a message to the second wireless device. Additionally, the service can send information about the second device to the third wireless device. This message can include information including but not limited to name, number, or some group affiliation of the owner of the third device. The information can be sent over the first network or over another network such as a cell phone network.

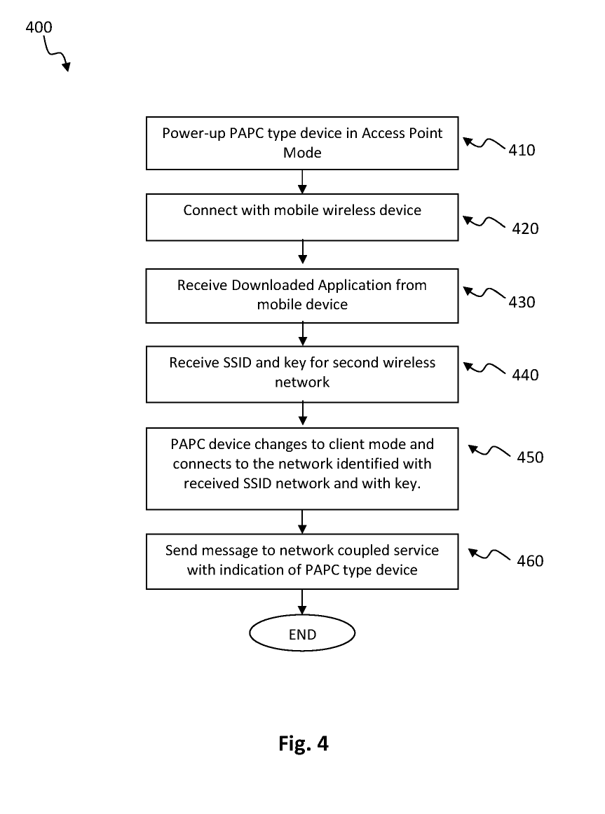

Referring to FIG. 4, a process diagram 400 for automatically downloading and configuring a wireless device is disclosed. Exemplar of this process is a new wireless device that is configured from a cellular phone where the new wireless device's application software is downloaded over a WiFi or cellular network.

In a first step 410, a PAPC (pulse access point client) wireless device enters into an access point mode, either after power up or from client mode after an event including but not limited to a hardware or software error or timeout. The device will remain in the access point mode until configuration or downloading is complete. While in access point mode, the PAPC device forms a first wireless network and transmits a device identifier. The communication standard is preferably IEEE 802.11 WiFi and IEEE 802.15 Bluetooth. The identifier for the wireless device is preferable a SSID (Service Set Identifier) that uniquely identifies the PAPC wireless device.

In a step 420, a mobile wireless device connects to the PAPC device while in the access point mode. Preferably, while the PAPC device is in access point mode and does not require a security key to connect to the PAPC device.

In a step 430, the mobile wireless device downloads data over the network formed by the PAPC wireless device.

In a step 440, the mobile wireless device transmits a wireless identifier and security key for the wireless network to which the PAPC device is to connect. Preferably the wireless network identifier is the SSID and the security key is a WEP (Wired Equivalent Privacy) key.

In a step 450, the PAPC device switches from an access point device to a client mode device and connects to the wireless network identified by the downloaded wireless identifier and useing the downloaded security key.

In an optional step 460, a message is sent to a network coupled service over the wireless network identified by the SSID indicating successful download of data or configuration.

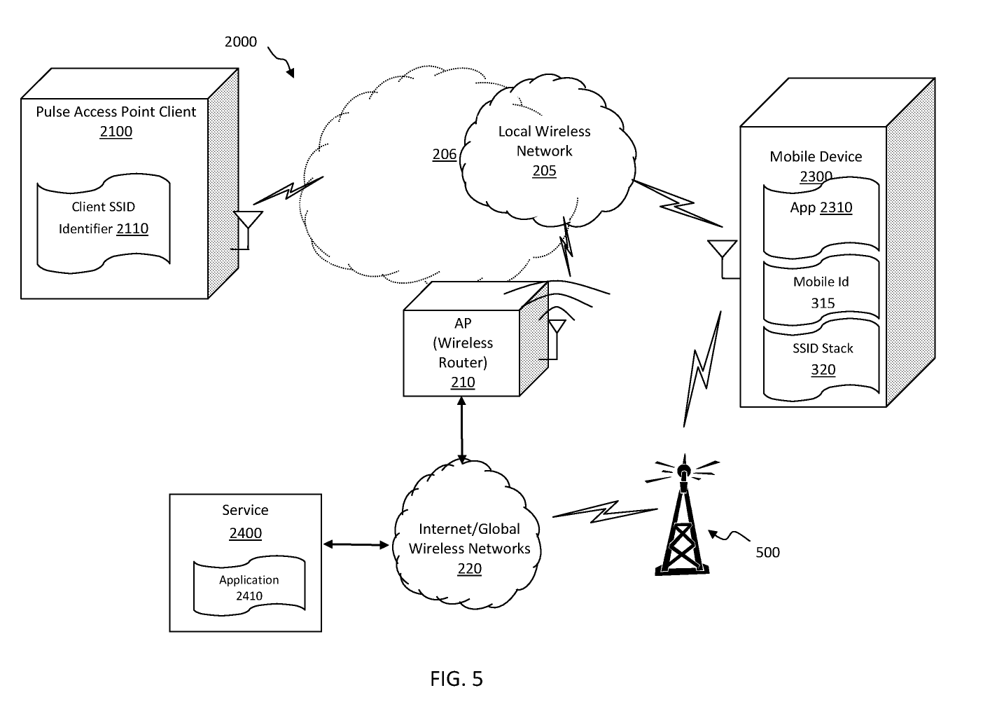

FIG. 5 is a block diagram of a system 2000 for executing the process to download or configure a wireless device from another wireless device. The data to be downloaded to the wireless device 2100 includes but is not limited to data for applications, test, maintenance data, and configuration data. In certain states, such as pre-device configuration, the PAPC device 2100 requires application download, maintenance, and configuration.

The PAPC device 2100 has a novel and non-obvious characteristic in that operates some of the times as wireless access point device and at other times operates as a client wireless device. When in the access point mode, another wireless device 2300 will connects to the PAPC 2100 device over the overlay wireless network 206 formed by the PAPC 2100 while in the access point mode. Applications are then downloaded over the established wireless connection using the overlay network 206.

Applications can be downloaded to the PAPC 2100 when the PAPC 2100 device is initialized for the first time. The PACP 2100 either powers up into access point mode or enters this mode when an update or maintenance is required. When in the access point mode, the PAPC 2100 operates like the AP 210 (Access Point Wireless Router) in that it provides wireless connectivity to which wireless client devices can connect. Preferably, the PAPC 2100 communication is based on IEEE 802.11(a, b, g, and n) WiFi or IEEE 802.15 Bluetooth for communication and does not require a WEP key or any other security key to access the device. The PAPC 2100 is configured with sufficient software for wireless communications and to download an application. Further, the PAPC 2100 could include a micro-web server that provides and interface for communication and control with the PAPC 2100 device.

The PAPC 2100 communication means will use an identifier recognizable by communication software on the mobile device 2300. For WiFi networks, based on the IEEE 802.11(a, b, g, and n) standard, a SSID 2110 (Service Set Identifier) is used to identify the access point router. Preferably the identifier incorporated data that identifies the type of device. For example, the transmitted SSID 2110 can be a character string such as “FeedAir***” where “FeedAir” identifies a specific type of device from which associated software is to be downloaded.

While in the access point mode, the PAPC 2100 forms an overlay network 206. The mobile wireless device 2300 establishes a wireless connection with the PAPC 2100 device through the overlay network 206. The PAPC device 2300 is configured with sufficient software to download applications. This software can include but is not limited to software to execute protocols, TCP, UDP, and IP, and loaders for receiving, storing, and executing the downloaded applications.

The mobile wireless device 2300 can be preloaded with the application 2310 to be downloaded or can receive the application 2410 from another network. This network could include but is not limited to the cellular network data networks 500 or the Internet 220. In one embodiment, the mobile device 2300 sends the received identifier to a network coupled service 2400. The service registers the PAPC device based on the identifier. The service 2400 transmits the one or more applications 2410 to the mobile device 2300 for downloading to the PAPC 2100. Further, the downloaded information can include the information required to connect to the AP wireless router. This information would include the SSID for the wireless router 210 and any required security key.

After the download of the application 2310, the PAPC device 2100 will reconfigure from access point mode to client mode. With the SSID for the AP 200 wireless router and the security key, the PAPC device 2100 can now connect and utilize the network 205 provided by the AP 210.

### OPERATIONAL EXAMPLES

In operation, an embodiment of the invention is described. The description that follows is for a system, method, and device that provides for the automated notification that a mobile device is in a geographic area based upon the mobile device detecting a PAPC (pulsed access point client) wireless device. Described differently, the mobile wireless device automatically detects a PAPC type device operating as a pulsed access point client, and identifies a mobile device identifier to the PAPC device. The PAPC device sends information regarding the detection of the mobile device by the PAPC device to a network services for an automated association. Other mobile devices that have detected the same PAPC device can be associated and notifications sent to the mobile wireless device or other devices of their associations and thus proximity. Thereby this system provides an automated method to associate the two devices, and optionally a geographic location, without requiring user input to the mobile wireless device. Further, this method provides the unique benefit of not requiring the mobile device to have a means to determine its geographic location. The known and preconfigured location information of the PAPC device provides a proximate location of the mobile device.

For this exemplar description, the unique type of wireless device shall be referred to as a PAPC (pulsed access point client). In a typical WiFi wireless network configuration there is a wireless router that operates as an AP (access point) for wireless client devices. One AP device provides connectivity between the Internet and one or more wireless clients. The clients connect to the wireless network based on an associated AP device SSID (Service Set Identifier) and optionally a digital security key. The AP identifies itself by wirelessly transmitting an SSID which identifies the wireless network. Client devices include laptops, smart phones, tablet computers, and other specialized devices that need to be connected to the Internet or to other client devices connected to the wireless network through the AP.

When client devices are in proximity with the wireless router, the AP transmits its SSID and the client device's wireless software loads the SSID into a software stack containing other SSID's it has received. If the wireless software is configured to connect to a specific SSID, and the specific SSID is seen, then a connection is attempted and established if possible. If not configured to establish a connection, then the SSID just remains in the wireless software stack.

A PAPC capable device operates in a non-standard and non-obvious mode that makes it both able to operate as a client device but also operate to provide an automated association between a mobile wireless device and the PAPC while operating within a wireless network. The PAPC operates by periodically and for a short period of time toggling from the client mode to AP mode. When this occurs, there are two wireless networks that either partially or totally overlay each other, one formed by the PAPC device and the original wireless access point. However, no client devices will connect with the PAPC while in the access point mode because no client device should ever be configured to connect to the PAPC access point device. Further, attempts to connect to the PAPC would always fail because the PAPC device quickly switches back to the client mode.

When the PAPC switches from client mode and into the access point mode, it sends out an SSID unique to PAPC device. The mobile device is configured with wireless software that includes stack or other data structure of received SSID's. The PAPC's SSID is not a preselected access point to which any mobile or client device will try to connect. The PAPC's SSID will be stored in the mobile device wireless software SSID stack or other data structure. However, the mobile device will have a background application active that periodically searches the mobile device's SSID stack looking for a PAPC type SSID. If the PAPC type SSID is found in the mobile device's wireless SSID stack or data structure, then after the PAPC switches back to a client device, the mobile device software that detected the PAPC type SSID sends a token to the PAPC device, while in the client mode, through the original wireless access point device. This token contains an identifier that uniquely identifies the mobile device.

Next the PAPC sends to a network coupled service the association information. This information can include an identifier of the mobile device, an identifier of the PAPC, the time and date that the association was made, and any preconfigured information including but not limited the geographic location of the PAPC. The service will store the association in a database. The service can search the database and determine if other mobile devices are associated temporally with this specific PAPC. These associations can further be narrowed by defined groups with which the mobile devices are associated. These groups can include but are not limited to friends, company members, and other associations. If other associations between the PAPC devices and other mobile device are found and they have not timed out, then a notification message can be sent to the mobile devices with a current same PAPC association. The application software on the mobile device or the service can send a token every few minutes. When these tokens stop, the service can ascertain that the mobile device has left the area and update the database as needed. Alternatively, a timeout can be used for when the mobile devices has left the geographic area of the PAPC. The Service has the option to then send a message to mobile devices that are currently still associated with the PAPC, that the particular mobile device appears to have left the area of the wireless network.

### Additional Embodiments

In the following exemplar embodiments of the invention, the systems provide for the automatic association of wireless devices using the devices, systems, functions, features, and methods of associating a PAPC (pulse access point client) type device with another wireless client device along with additional systems, functions, features, methods and devices. The systems, methods, and devices in the following embodiments include all or a combination of system, features, methods, and devices found in the provisional patent application 61/465,401 titled “Device, Method of a System for Providing Network Services over a Phone Line; Providing Presences based Display of Messages; Secure Sharing of Network Access” filed Mar. 17, 2011. Further, the embodiments can include the methods, functions, features, systems and devices disclosed in provisional patent application 61/571,201 “Device, Method and System for Feeding a Pet; Providing Network Services over a Phone Line; Providing Presences Based Display of Messages; Secure Sharing of Network Access” filed Jun. 23, 2011. Both provisional patent applications 61/465,401 and 61/571,201 are incorporated by reference. In these embodiments, the devices in these system's embodiments incorporate the inventive method and system of the PAPC (pulse access point client) device as described above and the device incorporates the software function and method that searches a device's wireless software stack or other data structure for a PAPCfied SSID type.

Specifically, multiple PAPC type devices can be used in forming building a social network. Specifically, a PAPC device can detect another PAPC device, report the detection to a network coupled service, and send information or invitations to devices associated with the owners of the PAPC devices.

Previous descriptions of the system had one device configured as a PAPC type device and the other as a mobile device that detects the PAPC type device. The system can be expanded by having multiple PAPC type device that detect other PAPC type devices. Thus, a social network of PAPC devices can be detect, associated on service, and information exchanged between associated users. One embodiment of this system would be for PAPC pet-care devices detecting nearby pet-care devices. The detection would be reported to a network coupled service which could send an email or a Facebook® pet friend request to the associated owners of the pet care device. Thereby, a social network is formed by pet owners with a PAPC type pet-care device that are in proximity to other pet-care devices.

### Display Device Embodiment

In this embodiment, the system has more than one network coupled PAPC type wireless display devices and mobile devices. Further, the wireless display devices are configured to switch between a client mode and an access point mode. Such a device configuration was previously referred to as a PAPC device and the details of this operation are described above. For the point of illustration, the display devices are referred to as display device PAPC-A and PAPC-B. In this embodiment, PAPC-A and PAPC-B devices are also configured with application software that receives and displays messages when a mobile device is detected to be in proximity to the display device.

In operation, the display device PAPC-B switches into a wireless access point mode. Upon switching into access point mode, the display device PAPC-B transmits an SSID, for example “FeedAir12345”, unique to the PAPC-B device. The PAPC-A, while in client mode, will receive the unique PAPC-B SSID and store it in the PAPC-A's wireless SSID stack. This SSID, not being one to which the PAPC-A is configured to establish a connection will be stored in the software SSID stack of the display PAPC-A device. Further, the PAPC-A display device is configured as a display device and includes the software and features as described in the above provisional application. This includes the feature of periodically scanning the wireless SSID stack for a PAPC type of SSID. Further, the scan can be limited to scanning for a FeedAir type SSID. Upon finding any SSID's of the type “FeedAirxxxx”, the PAPC-A sends a notification message to a network coupled service.

Each PAPC type device has a unique SSID or an associated unique identifier that is sent back to the network coupled service. The service will have a unique association between each PAPC type device SSID or other device supplied unique identifier and an associated user device to which a message can be sent. This service can send a message to a user device associated with each of the PAPC-A and PAPC-B devices or to the devices themselves. The message can include but is not limited to a text message, an email, or a combination thereof. The devices to which the notifications can be sent can include but are not limited to an associated PAPC display device, a mobile phone, a tablet computer, a personal computer, or a combination thereof.

Next the network coupled service sends information that includes information associated with the corresponding PAPCs. For example, the service may send to the PAPC-A associated user device information that the associated user of PAPC-B may want to share. The information can be of a social nature, of a commercial nature, or a combination thereof. For example, after the association of the two display devices PAPC-A and PAPC-B, the network coupled service can send to a PAPC-A associated user device local business information that the associated PAPC-B user would want share. An example of social information could include information about the time and place of a social gathering, contact information, hobbies of the associated PAPC-B user, neighborhood information or a combination thereof. Further, the message could have a Facebook™ name to which the two associated users could establish contact. In this manner, the PAPC display devices in the same geographic area can be used to establish a social network based on the devices being within a limited geographic area.

Some or all of this information stored on the network couple service can have an associated indication that the information is shareable, with whom the information is sharable, or what type of associated user can receive this information.

### Pet Care Embodiment

In yet another embodiment of the invention, the system has one or more pet care and feeding devices coupled to one or more wireless networks. Each pet care device is configured to include the PAPC feature of switching between a wireless client mode and a wireless access point mode as discussed above. For the point of illustration, the system will have one or more pet care PAPCs, referred to as pet care PAPC-A and pet care PAPC-B. In this embodiment, PAPC-A and PAPC-B are configured with application software that monitors the activities of a pet and manages pet feedings is as described in the above incorporated provisional application 61/571201. Further the pet care PAPC devices include software to search the wireless SSID stack for a specific type of PAPC device.

In operation, pet care device PAPC-B periodically switches into an access point mode. Upon switching into access point mode, the PAPC-B device transmits a device unique SSID, for example “PetCare12345.” The pet care device PAPC-A, while in client mode, will receive the pet care device's PAPC-B unique SSID and stores the SSID in the wireless software SSID stack. This unique PAPC-B SSID is not an SSID which the pet care device PAPC-A is ever configured to connect.

Upon finding any SSID's of the type “PetCarelinexxxx”, the PAPC-A sends a notification to a network coupled service that includes a PAPC-A unique identifier and the identifier for PACP-B. The service will have a unique association between each PAPC type device SSID or other unique identifier and one or more associated user devices to which a message can be sent. This network coupled service can send a message to a user device associated with one or both of the pet care PAPC-A and PAPC-B devices. The notification can include but is not limited to a text message, an email, a display message for a user associated PAPC display device, or a combination thereof. The devices to which the notifications can be sent can include but are not limited to an associated PAPC display device, a mobile phone, a tablet computer, a personal computer, or a combination thereof.

The network coupled server can include information associated with each PAPC device. Some or all of this information can have an indication that the information is shareable and can be of interest between pet owners. An user associated device message can include some or all of this information. For example, since the pet care PAPC should only have a range at most of a few hundred yards, other users of PAPC pet care devices could learn about what other pet owners are nearby, the types of pets, and whether owner is interested in watching a pet. Further, the associated device message could share information including but not limited to pet type, breed, and gender. Additionally, the user associated device message could refer the associated pet owner to a social networking web site for pet owners or Facebook® where the pet owners associated with PAPC-A and PAPC-B pet care devices could share further information. In this manner, PAPC devices in the same geographic area can be used to establish a social network for pet owners.

### Elder Care System

In yet another embodiment of the invention, the system has one or more elder care monitoring devices coupled to one or more wireless networks. Each elder care monitoring device is additionally configured as a PAPC type device as described above. The system elder care PAPCs, which for the point of illustration, are referred to as elder care device PAPC-A and PAPC-B. In this embodiment, PAPC-A and PAPC-B are configured with application software that monitors the activities of an elderly person's phone activity and parameters of an elderly person's voice to monitor the wellbeing of the elderly person. A further description of these features, systems and functions can be found in the incorporated provisional patent application 61/465,401.

In operation the elder care PAPC-B device switches into access point mode. Upon switching into access point mode, the eldercare PAPC-B device transmits a unique SSID, for example “ElderCare12345.” The PAPC-A, while in client mode, will receive the PAPC-B SSID and store it in the wireless SSID stack. This SSID is not an SSID to which the PAPC-A is configured to connect. Software on PAPC-A and PAPC-B are also configured as an elder care monitoring device as described in the above incorporated provisional application, will scan the wireless SSID stack. Upon finding any SSID's of the type “ElderCarexxxx”, the PAPC-A sends a notification to a network coupled service. Each PAPD type device will have a unique SSID or an associated identifier that is sent back to the network coupled service. The service will have an association between each PAPC type device SSID or another unique identifier and an associated user device to which a message can be sent from the service. This network coupled service can send a message to the user devices associated with the PAPC-A and PAPC-B devices. The notification can include but is not limited to a text message, an email, a display message for an associated PAPC display type device, an audio message, or a combination thereof. The devices to which the notifications can be sent can include but are not limited to an associated PAPC Elder care device, and PAPC type display device, a mobile phone, a tablet computer, a personal computer, or a combination thereof.

The network coupled server can include information associated with each of the elder care PAPCs and one of more user associated devices. Some or all of this information can have an indication that the information is shareable and can be of interest between neighboring elderly people. A notification message can include some or all of this information to the devices associated with the elder care PAPC-A and PAPC-B devices. For example, since the elder care PAPC device should only have a range at most of a few hundred yards, other users of PAPC elder care devices would learn through their associated devices about what other elderly people live nearby. Further, the notification message could share information including but not limited to personal interest, and social activities. Additionally, the notification message could refer the user associated with the PAPC-A and PAPC B to a social networking web site, such as FaceBook®, where the elderly could share further information and make social connection. In this manner, elder care PAPC devices in the same geographic area can be used to establish a social network for the elderly.

### Mobile Phone

In this embodiment, the system has more than one wireless mobile devices and a base station. Exemplar wireless mobile device includes but is not limited to a cell phone. Exemplar base station includes but is not limited a cellular tower base station. Unlike the operation of current commercial provided cellular phones, one of the mobile devices is configured to switch between a cellular phone mode and base station mode. When the mobile device switches into the base station mode, it broadcasts an inquiry message as to what other mobile cellular devices are within reception range. The inquiry message has a unique identifier or part of the identifier that will identify is as being relate a PAPC type devices. Preferably, the inquiry message is transmitted at a low power to limit the number of mobile devices that respond.

For the point of illustration, the mobile devices are referred to as device MOBILE and PAPC-A. In this embodiment, the MOBILE device is configured with application software that receives base station inquiry messages that recognizes the base station identified PAPC-A device as coming from a PAPC type mobile device. Further, the PAPC-A device can be physically positioned to a known location where a network coupled service can be configured with the location information and other information for the MOBILE device.

In operation, the mobile device PAPC-A will switch into a base station mode. Upon switching into base station mode, the mobile device PAPC-A broadcasts a base station identifier unique to the PAPC-A device and identifiable as a PAPC type device. The MOBILE device receives this unique PAPC-A base station identifier and stores it in the MOBILE device's cellular base station identifier stack or other base-station related data structure. The MOBILE device is configured with software to scan the wireless base-station stack or data structure containing base station information for a PAPC type of base-station identifier. Upon finding any the PAPC type base-station identifier, the MOBILE device sends a notification message to a network coupled service. The message will include a unique identifier for the PAPC-A device and an identifier for the MOBILE device. The network coupled service can have a unique association between each PAPC-A device and a mobile user device to which a message can be sent. For example, the association may be an email of the MOBILE device, a phone number for sending a text message, or a Facebook account name. For example, the message might contain “Welcome back to the store and you might be interested in the sale on X that we are having today.” The network coupled service can send the message to the MOBILE device or another device, or another network couple service. The message can include but is not limited to a text message, an email, or a combination thereof. Other network coupled services can include Facebook® or Google+® where a message sent to these services will be pulled to a user associated device. The devices to which the message can be sent can include but are not limited to an associated PAPC display device, a mobile phone, a tablet computer, a personal computer, or a combination thereof. Preferable the message is sent to the MOBILE device.

### PAPC Device Initialization

In a further aspect of the invention, the PAPC devices can be initially configured with mobile device. The first time that a PAPC device powers up and until the PACP device is configured, the device powers up in access point mode. The PAPC device is also configured with an SSID that identifies it as a PAPC type device. Preferably, the means by which the mobile device and the PAPC device communicate are through wireless communication medium. This communication medium can include WiFi or blue tooth communication protocols. Preferably, the communication range is limited to a short range, less than 300 feet, to prevent the misconfiguration of a PAPC device. When a mobile device configuration application is executed, a client device, will connect to the PAPC device. The mobile device can then download one or more application programs and configuration parameters for the PAPC device. Further, the mobile device downloads the SSID and security key of other wireless routers to use for communication with network coupled services.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A system for automatically associating a first wireless device with a second wireless device comprising:
a first wireless device that toggles between client mode and access point mode and configured to communicate through a first wireless network associated with a first access point device, wherein the first wireless device forms a pulsed overlay wireless network when in the access point mode, and wherein the first wireless device transmits a unique identifier over the pulsed overlay wireless network upon switching into the access point mode, and wherein the first wireless device is configured to receive a token over the first wireless network when in the client mode;
a second client wireless device configured to receive the unique identifier over the pulsed overlay wireless network, wherein the second wireless devices is configured to search a data structure associated with the second wireless device for the unique identifier, wherein upon finding the unique identifier a token is transmitted over the first wireless network, and wherein the token is configured with a mobile device identifier that uniquely identifies the second client device.

2. The system of claim 1, further comprising a network coupled service, wherein the first wireless device, while in client mode, sends a message to the service containing the mobile device identifier and a first wireless device identifier.

3. The system of claim 2, wherein the service stores in a database the association between the first and second device and search for a third wireless device associated with the first wireless device.

4. The system of claim 3 wherein the service sends a message to second wireless device with an identifier of the third wireless device.

5. The system of claim 4 are configured to communicate using one of the following communication protocols, IEEE 802.11a, b, g, and n or IEEE 802.15.

6. A method of automatically associating a first wireless device with a second wireless device over a first wireless network comprising the steps of:
configuring a first wireless device to switch from client mode to access point mode thereby forming a pulsed overlay wireless network;
transmitting wirelessly from the first wireless devices a unique identifier while configured in the access point mode over the pulsed overlay wireless network;
receiving by a second wireless device the unique identifier over the pulsed overlay wireless network;
switching the first wireless device from access point mode to client mode;
searching a data structure coupled with the second wireless for the unique identifier; and
sending a token from the second wireless device to the first wireless device over the first wireless network when the unique identifier is found in the data structure of the second wireless device, wherein the token comprises a unique second wireless device identifier.

7. The method of claim 6 wherein the unique identifier contains a field that identifies the device as PAPC type device.

8. The method of claim 7 further comprising the steps:
sending a message from the first device to a network coupled service, wherein the message contains the first wireless device identifier and the second wireless device identifier, and wherein the association of the first wireless device and the second wireless device is stored in a database couple to the service.

9. The method of claim 8 further comprising the step:
searching the database for a third wireless device associated with the first wireless device and sending a notification over the first network from the network coupled service to the second wireless device, wherein the message contains information in the database associated with the third wireless device.

10. A wireless device configured to automatically associate with a second wireless device comprising:
electronics configured to toggle between client mode and access point mode, wherein the device is configured to communicate through a first wireless network associated with a first access point device when configured in client mode, wherein when the device is configured in access point mode the device forms a pulsed overlay wireless network, and wherein the wireless device transmits a unique device identifier over the pulsed overlay wireless network upon switching into the access point mode, and wherein while in the client mode the device is configured to receive a token comprising a second wireless device identifier over the first wireless network sent from a second wireless device.

11. The device of claim 13, further configured to send a message to a network coupled service over the first wireless network, wherein the message contains the second wireless device identifier and the first wireless device identifier.

12. The device of claim 11 configured to communicate using the communication standards specified by IEEE 802.11a, b, g, and n or IEEE 802.15.
